(19) United States
(12) Patent Application Publication
(10) Pub. No.: US 2019/0050654 A1
(43) Pub. Date: Feb. 14, 2019

(54) System and Method for Determining Vehicle Occupancy for Enforced Areas

(71) Applicant: Miovision Technologies Incorporated, Kitchener (CA)

(72) Inventors: Kourtney B. PAYNE-SHORT, Kitchener (CA); Justin A. EICHEL, Kitchener (CA)

(21) Appl. No.: 16/049,296

(22) Filed: Jul. 30, 2018

Related U.S. Application Data
(60) Provisional application No. 62/544,547, filed on Aug. 11, 2017.

(51) Int. Cl. G06K 9/00; G06N 3/08; G06K 9/46; G06K 9/32

(52) U.S. Cl. CPC G06K 9/00838; G06N 3/08; G06K 2209/15; G06K 9/3258; G06K 9/4604

(57) ABSTRACT

A method includes acquiring an image in the vehicle after determining that the vehicle is in or approaching an enforced area, and enabling the vehicle occupancy to be determined by wirelessly sending the image or a value indicative of the vehicle occupancy to an occupancy determining system. Determining vehicle occupancy can include receiving a vehicle identifier obtained by a vehicle detection camera at an enforced area; using the vehicle identifier to determine an associated user; sending a query to an occupancy app residing on a device for the associated user, the device being located in a vehicle corresponding to the vehicle identifier and configured to obtain in-vehicle images; receiving, in response to the query, an image or a value indicative of the vehicle occupancy to determine the vehicle's occupancy; and sending an occupancy event to an enforcement agency associated with the enforced area.

### CROSS-REFERENCE TO RELATED APPLICATION(S)

This application claims the benefit of priority to U.S. Provisional Patent Application No. 62/544,547 filed on Aug. 11, 2017, the contents of which are incorporated herein by reference.

### TECHNICAL FIELD

The following relates to systems and methods for determining vehicle occupancy for enforced areas, in particular for determining vehicle occupancy for managed traffic lanes.

### DESCRIPTION OF THE RELATED ART

To ease traffic congestion, particularly during peak times such as the so-called rush hour periods, various mechanisms have been contemplated and deployed in various jurisdictions. For example, to encourage carpooling, transportation authorities may provide highway lanes restricted to high occupancy vehicles (HOVs), i.e. those vehicles with a plurality of occupants. These HOV lanes, also known as carpooling lanes can incentivize those individuals willing to reduce the number of vehicles on the roadways by providing access to presumably lighter-travelled and thus less congested lanes. A similar principle can be applied to provide preferred parking spaces to carpoolers.

A major difficulty with the provision of HOV or carpooling lanes is enforcement, because it can be challenging to accurately detect vehicle occupancy while maintaining traffic flow—i.e. without causing vehicles to stop at an access point such as a toll booth or checkpoint. Because of this, transportation authorities are often left with relying on voluntary compliance by drivers and/or the need for enforcement officers to spot non-compliant vehicles.

It is an object of the following to address at least one of the aforementioned drawbacks.

### SUMMARY

A system is herein described that utilizes images of vehicle occupants acquired from within the vehicle to control enforcement of areas that require a particular vehicle occupancy or require knowledge of the occupancy, such as in managed traffic lanes, parking lots, border crossings, etc.

In one aspect, there is provided a method of enabling vehicle occupancy to be determined, the method comprising: acquiring an image in the vehicle after determining that the vehicle is in or approaching an enforced area; and enabling the vehicle occupancy to be determined by wirelessly sending the image or a value indicative of the vehicle occupancy to an occupancy determining system.

In another aspect, there is provided a method of determining vehicle occupancy, the method comprising: receiving a vehicle identifier obtained by a vehicle detection camera at an enforced area; using the vehicle identifier to determine an associated user; sending a query to an occupancy app residing on a device for the associated user, the device being located in a vehicle corresponding to the vehicle identifier and configured to obtain in-vehicle images; receiving, in response to the query, an image or a value indicative of the vehicle occupancy to determine the vehicle's occupancy; and sending an occupancy event to an enforcement agency associated with the enforced area.

In yet another aspect, there is provided a method of enabling vehicle occupancy to be determined, the method comprising: acquiring at least one audio recording obtained from within the vehicle after determining that the vehicle is in or approaching an enforced area; and enabling the vehicle occupancy to be determined by wirelessly sending the at least one audio recording or a value indicative of the vehicle occupancy to an occupancy determining system.

In other aspects there are computer readable media and systems for performing the above methods.

### BRIEF DESCRIPTION OF THE DRAWINGS

Embodiments will now be described with reference to the appended drawings wherein:

FIG. 1 is a schematic diagram of a system for determining vehicle occupancy for an enforced area;

FIG. 2 is a schematic diagram of a system for determining vehicle occupancy for managed traffic lanes;

FIG. 3 is a schematic diagram of an in-vehicle configuration for capturing an image showing a number of vehicle occupants;

FIG. 4. is a schematic block diagram of an in-vehicle occupancy analysis system;

FIG. 5 is a schematic diagram of an in-vehicle occupancy analysis system using a camera and app in a smartphone mounted in the vehicle;

FIG. 6 is a flow chart providing computer executable instructions for performing an in-vehicle occupancy app set up;

FIG. 7 is a flow chart providing computer executable instructions for querying a vehicle occupancy app based on the associated vehicle being detected in a managed lane and for coordinating with a transportation authority therefor;

FIG. 8 is a flow chart providing computer executable instructions for one example of a process for arranging a fine or toll payment;

FIG. 9 is a flow chart providing computer executable instructions for another example of a process for arranging a fine or toll payment; and

FIGS. 10a and 10b are portions of a flow chart providing an example of interactions between a user and the transportation authority.

### DETAILED DESCRIPTION

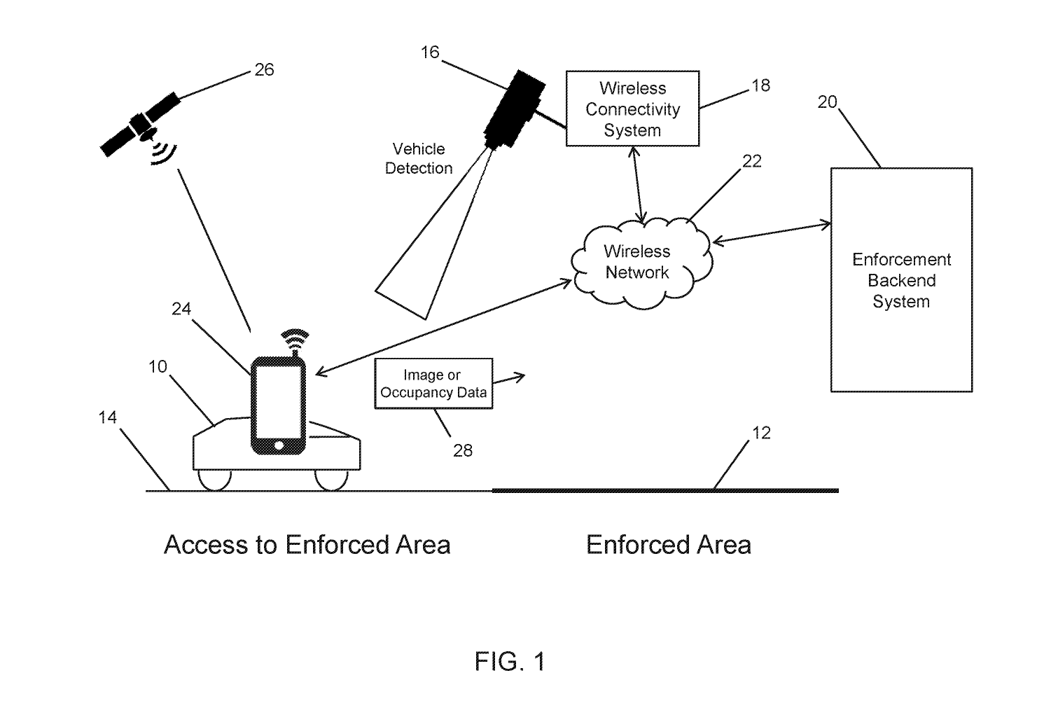

Turning now to the figures, FIG. 1 illustrates a vehicle 10 that is approaching and intending to enter an enforced area 12 in which the occupancy of that vehicle 10 is desired to be determined. In the example shown, the vehicle 10 is currently in an access point 14 to the enforced area 12 and the vehicle 10 is detected using a detection device 16. For example, an image of the vehicle 10 can be taken by a vehicle detection camera 16. Typically, such a detection camera 16 is used to obtain an image of an identifying attribute of the vehicle, most commonly a license plate. The detection camera 16 can be an advanced license plate recognition (ALPR) device. It can be appreciated that while the following examples may refer to a detection camera 16, other detection devices 16 such as dedicated short range communication (DSRC) or other vehicle-to-infrastructure devices that have or can be adapted to provide an identifying value or signal, might be employed in order to detect an approaching vehicle using other identifying attributes such as a unique identifier, etc.

The vehicle detection camera 16 is coupled to a wireless connectivity system 18 that provides a wireless connectivity capability to the vehicle detection system that employs the camera 16 to enable images of the vehicles 10 entering the enforced area 12 to be sent to an enforcement backend system 20 over a wireless network 22. An example of a suitable wireless connectivity system 18 is the Spectrum SmartLink™ LTE connectivity solution provided by Miovision Technologies Incorporated.

In the configuration shown in FIG. 1, the vehicle detection camera 16 is responsible for performing vehicle detection, while vehicle occupancy detection is performed from within the vehicle 10 as explained in greater detail below. The vehicle 10 can include a smartphone 24 or other wireless communication device such as an in-vehicle infotainment, roadside assistance or communication hub; to send an image or occupancy data 28 via the wireless network 22 to the enforcement backend system 20. In one example used herein, the image or occupancy data 28 is acquired/determined using images obtained from within the vehicle 10. Alternatively, the occupancy data 28 can be determined using another medium such as audio/voice content. In such an example, a “voice print” is generated using a device or devices in the vehicle 10 that can record and process audio data to identify occupants according to such voice prints. The device(s) can look for variances in the input to flag for misuse via a voice-recorder playback.

As explained below, such images (or audio recordings) can be acquired using any available imaging device such as the smartphone's camera, an in-dash camera, etc. The smartphone 24 or other electronic processing or communication device can use a location-based service such as a global positioning system (GPS) to associate a location with the in-vehicle occupancy image. This allows the backend enforcement system 20 to match the in-vehicle occupancy data 28 with instances in which the vehicle 10 was externally detected in the access area 14 by the vehicle detection camera 16. It can be appreciated that multiple in-vehicle cameras/smartphones 24 can also be coordinated in order to determine the occupancy. For example, the system described herein can be configured to coordinate one camera per occupant that are registered with the vehicle 10. That is, each smartphone 24 could register to a vehicle 10 and communicate directly with a registration server or other service.

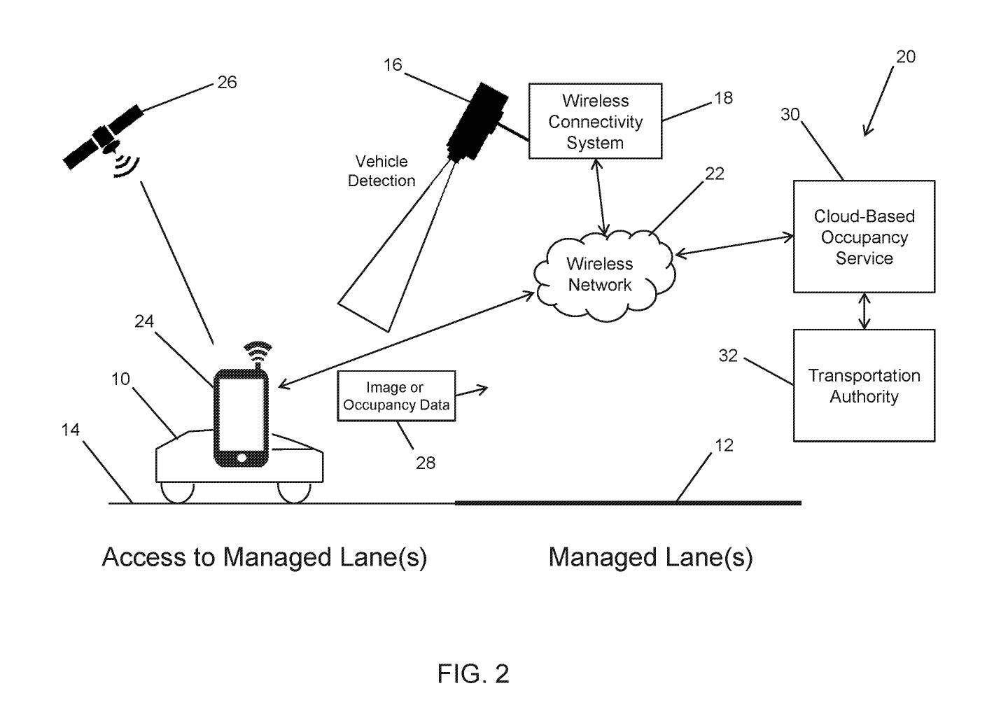

The backend enforcement system 20 which is shown generally in FIG. 1 can include one or more services and sub-systems to coordinate the acquisition of vehicle detection images and the enforcement of tolls or other usage fees, fines, etc. For example, FIG. 2 illustrates a similar configuration to that shown in FIG. 1 wherein the enforced area 12 is one or more managed traffic lanes. The backend enforcement system 20 in this configuration includes a cloud-based occupancy service 30 that is wirelessly connected to the vehicle detection camera 16 via the wireless connectivity system 18 and the in-vehicle communication systems via any wireless internet connection, to manage vehicle occupancy detection for a transportation authority 32. The enforcement aspect can be coordinated between the cloud-based occupancy service 30 and the transportation authority 32. It can be appreciated that the backend operations can be configured and coordinated in various other arrangements, such as by offloading all responsibilities onto the occupancy service 30, replicating those services within the transportation authority 32, or by having more than two entities involved.

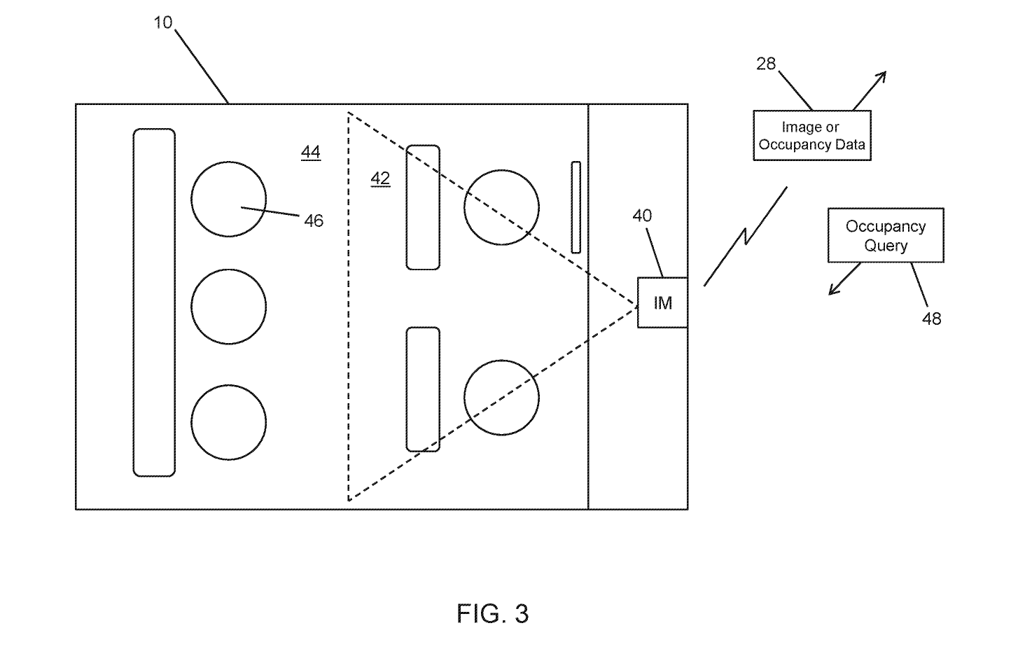

FIG. 3 illustrates an example of an arrangement for acquiring images within the vehicle 10. In this example, an imaging device 40 having a particular field of view 42 is positioned within the vehicle 10 to acquire an image of the vehicle interior 44 to determine how many people 46 are in the vehicle 10, including passengers and the driver. The image that is acquired can be sent to the occupancy service 30 or can be processed at the vehicle side to determine the occupancy data. The image or occupancy data 28 that is sent from the vehicle 10 therefore represents any data, values, information, files, packages, packets, etc. that is/are provided to the occupancy service 30 for the purpose of performing at least one backend operation. Images can be acquired periodically, to support managed lanes without controlled entrances and exits, or as described in the present example, an occupancy query 48 can be sent to a device associated with the vehicle 10 (e.g., smartphone 24) to obtain a location- and time-associated image or occupancy value for the purpose of enforcement for a particular enforced area 12.

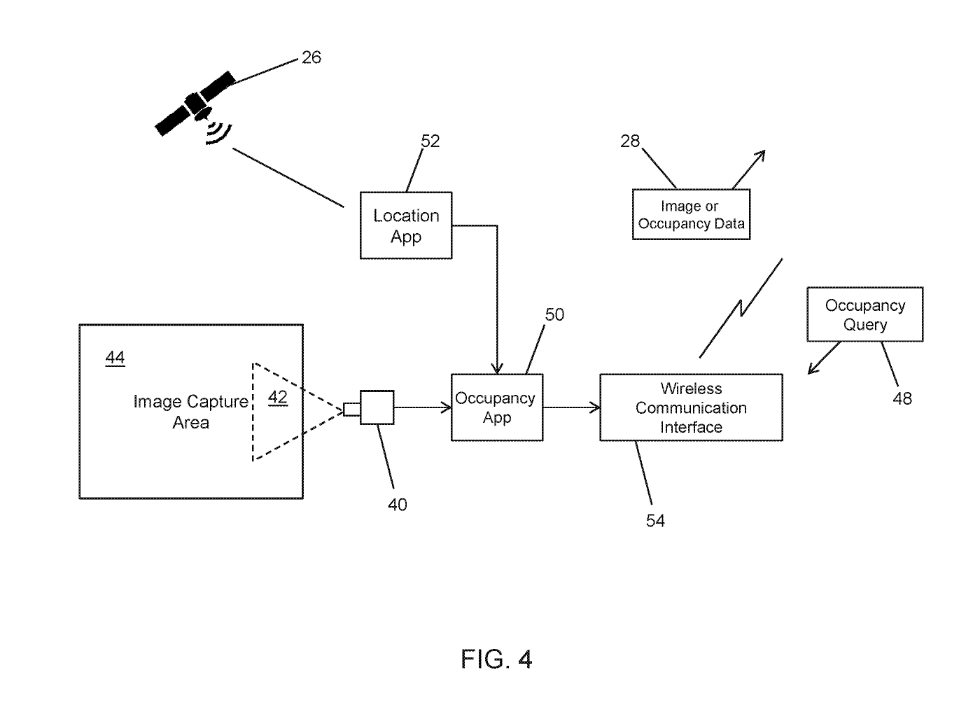

FIG. 4 illustrates an in-vehicle system for acquiring vehicle occupancy images/data and sending same to the occupancy service 30. In this example configuration, the imaging device 40 obtains an image within the vehicle 10 based on its field of view 42 and what is viewable at that time within the image capture area 44. This image is provided to an occupancy application (app) 50. The occupancy app 50 can also receive location-based data such as GPS coordinates from a location app 52 connected to a location-based service such as a GPS. The occupancy app 50 also has access to a wireless communication interface 54 that enables the app 50 to receive occupancy queries 48 from, and send image or occupancy data 28 to the occupancy service 30.

It can be appreciated that the configuration shown in FIG. 4 is generalized to show certain elements and these elements can be embodied in various forms. For example, the imaging device 40, occupancy and location apps 50, 52, location app 42 and communication interface 54 can all be provided by a consumer device such as a smartphone 24 that is mounted in the vehicle 10. However, these elements can also be provided by other in-vehicle devices known or contemplated such as in-vehicle infotainment systems, roadside assistance devices, driver behaviour monitoring trackers, etc.; or various combinations of such devices and systems. That is, the general configuration shown in FIG. 4 can be achieved using various electronic devices, including those aimed at consumers and vehicles.

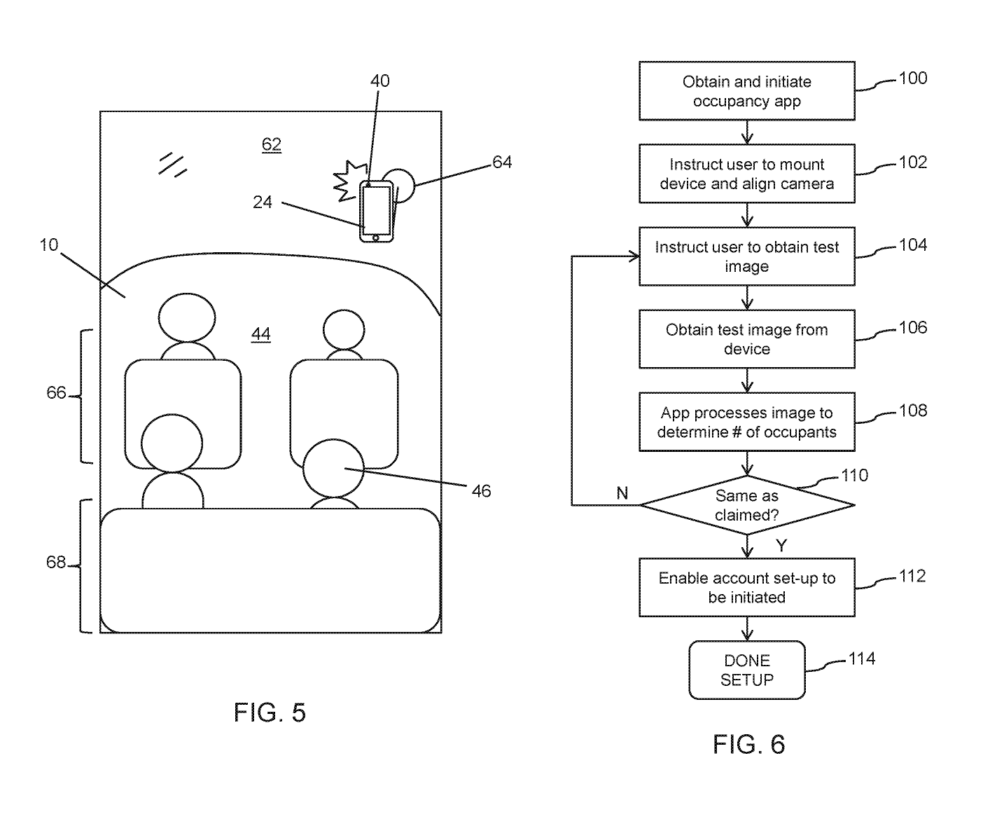

In FIG. 5, a smartphone-based configuration is illustrated in which a smartphone is mounted to a dashboard or in this case a windshield 62 of the vehicle 10 using a mounting device 64 such that the smartphone's camera 40 is directed towards the occupants 46 of the vehicle. In this illustration, the vehicle 10 includes occupants 46 in both the front seats 66 and the back seats 68 and includes four total occupants 46 that can be detected within images acquired by the camera 40. As explained in greater detail below, one or more computer vision algorithms can be employed by either an in-vehicle computing element such as the occupancy app 50 or the occupancy service 30 to find objects of interest within the acquired images and attribute those objects of interest to vehicle occupants 46. It can be appreciated that not all occupants 46 need to be detected in some applications, but rather only the minimum number needed to satisfy a particular criterion. For example, the four occupants 46 shown in FIG. 5 could also be detected as 2+ or 3+ and still satisfy the requirements for 2 or 3 occupant HOV lanes respectively.

To utilize the front-facing camera 40 on the smartphone 24 as shown in FIG. 5, the occupancy app 50 can guide the user through a set-up procedure as exemplified in FIG. 6. At step 100 the smartphone 24 is used to obtain (e.g. download and install) and initiate (launch) the occupancy app 50. It can be appreciated that the occupancy app 50 can be created by and/or made available by either the occupancy service 30 or the transportation authority 32, or in cooperation therebetween. Once the app 50 is initiated, the app 50 instructs the user to mount the smartphone 24 (e.g. on the dash or windshield 62) and to align the camera 40 at step 102. This can be done by aligning the smartphone 24 itself or any mounting device being used. The app 50 can provide any suitable user interface for doing so, such as by displaying a live view of the what the camera is currently seeing to assist in having the camera's field of view 42 capture both the driver and the other occupants 46. It can be appreciated that the photo of the image capture area 44 need not detect the driver of the vehicle as the algorithm can account for the driver as a default while looking for other occupants 46.

With the smartphone 24 mounted and aligned, the occupancy app 50 can instruct the user to obtain a test image at step 104, and obtain the test image at step 106. The occupancy app 50 either processes the image on the smartphone 24 or sends the image to the occupancy system 30 to have the image processed remotely in order to apply one or more computer vision algorithms to determine the number of passengers (or total occupants) at step 108. The occupancy app 30 may then display the results to the user at step 110 to have the user confirm that the processed results are the same as the actual vehicle occupancy. If not, the user can be instructed to reposition and repeat the test image process by returning to step 104. Once the imaging process has been calibrated, the occupancy app 30 can direct the user to initiate an account set-up process at step 112. It can be appreciated that the account set-up process can instead be performed prior to the in-vehicle camera set up and is shown as step 112 for illustrative purposes only. The account set-up process can include associating the license plate of the vehicle 10 with a user account and/or payment method. This can be done directly with the transportation authority 32 or the occupancy service 30, via the occupancy app 50, through a web browser, etc. The setup process is completed at step 114 after the camera and account set-up processes are complete and the occupancy app 50 is ready for operation.

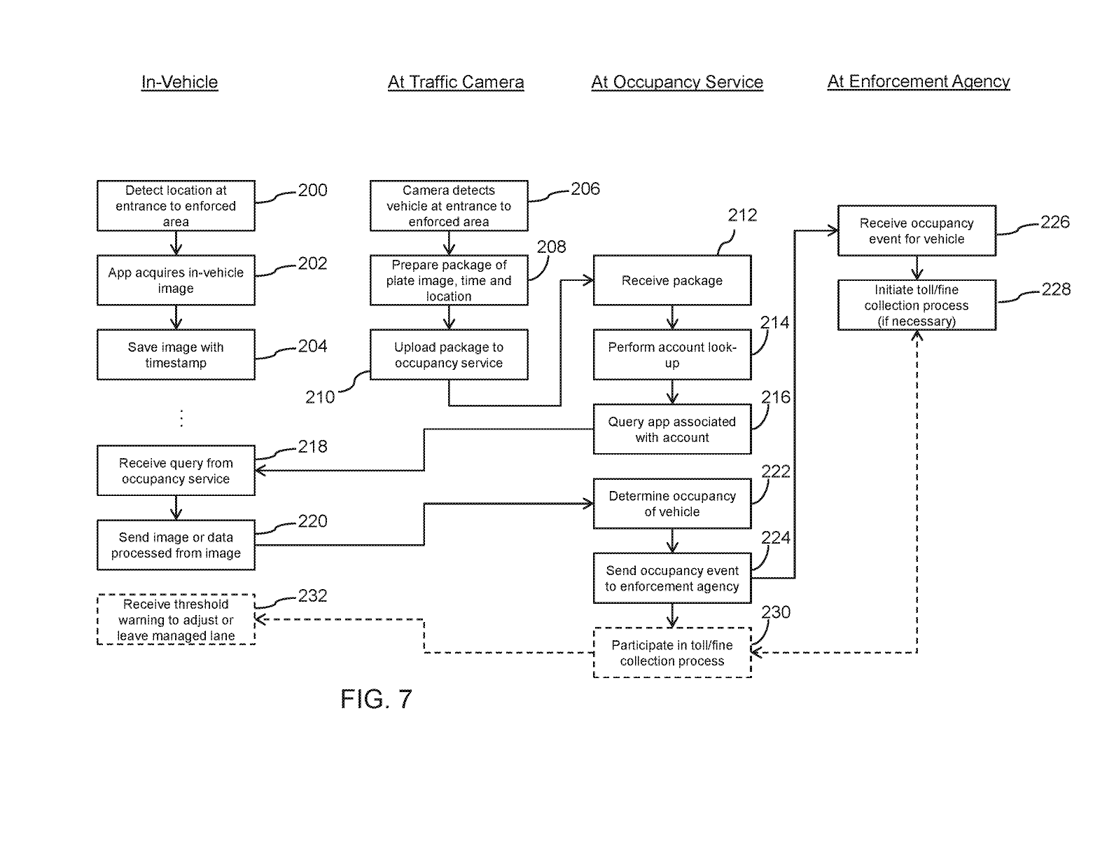

Turning now to FIG. 7, an overview of an example enforcement process is shown. At step 200 the occupancy app 50 detects that the current location of the vehicle 10 is within the enforced area 12 or preferably within or approaching the access area 14. For example, when the GPS 26 and location app 52 determine that the vehicle 10 is at the entrance to an managed traffic lane 12 such as an HOV or carpool lane, the occupancy app 50 causes the front-facing camera 40 to acquire an in-vehicle image and saves that image with a timestamp and GPS location at step 204. To minimize the processing power and network data usage requirements, as well as to address potential privacy concerns, the occupancy app 50 can simply retain the image, timestamp, and location until it is queried by the occupancy service 30. As indicated above, the image can be processed by the occupancy app 50 or by another application or routine on the smartphone 24, or can be uploaded to the occupancy service 30 to offload this processing. It can be appreciated that which processing mechanism is used can be chosen to suit the particular application, processing requirements, data usage limits, etc.

In the example shown in FIG. 7, at or near the same time that the occupancy app 50 is obtaining the in-vehicle image, the vehicle detection camera 16 detects the vehicle at the entrance 14 to the enforced area 12 at step 206 and prepares a data package at step 208 that includes the license plate image, time, and location. This data package is then uploaded at step 210 to the occupancy service 30, e.g., over a virtual private network (VPN), which is received by the occupancy service 30 at step 212. The occupancy service 30 performs an account look-up operation at step 214 to associate the detected license plate with account established through the occupancy app 50. In this way, the occupancy service 30 can query the associated app 50 on the in-vehicle mounted device at step 216.

The occupancy app 50 receives an occupancy query 48 at step 218 for a record of the vehicle occupancy at the time when and location where the detection camera 16 detected the vehicle 10. The app 50 sends either the image, location and timestamp, or occupancy data processed by the app 50 itself to the occupancy service 30 at step 220. The occupancy service 30 either determines from the data or by processing the image the vehicle occupancy at the associated time and location at step 222. The occupancy service 30 at this time can also be operable to adhere to privacy or other data access or retention restrictions to dispose of records according to the transit authority's rules. For example, the occupancy service 30 may delete records that show no violation in an HOV lane or create a billing record for a record that does not shown high occupancy in a toll lane, etc. Encryption and data access logging can also be performed as optional data protection measures. In this way, once the occupancy-related event is determined for the purpose of enforcement, the user-specific data can be disposed of.

The occupancy event may then be sent at step 224 to the enforcement agency such as the transportation authority 32, which is received and processed at step 226. The enforcement agency may then initiate a billing or enforcement process at step 228 if necessary and can optionally have the occupancy service 30 participate in the toll/fine collection process at step 230. It can be appreciated that as shown in dashed lines in FIG. 7, the occupancy service 30 and occupancy app 50 can be configured to incorporate threshold grace periods or employ other warning via the app 50. For example, within a threshold time or distance travelled, the app 50 can display a warning to the user that they are in a managed lane with an insufficient occupancy detected. This allows the user to adjust or recapture the occupancy image, or leave the managed lane without triggering a toll or fine.

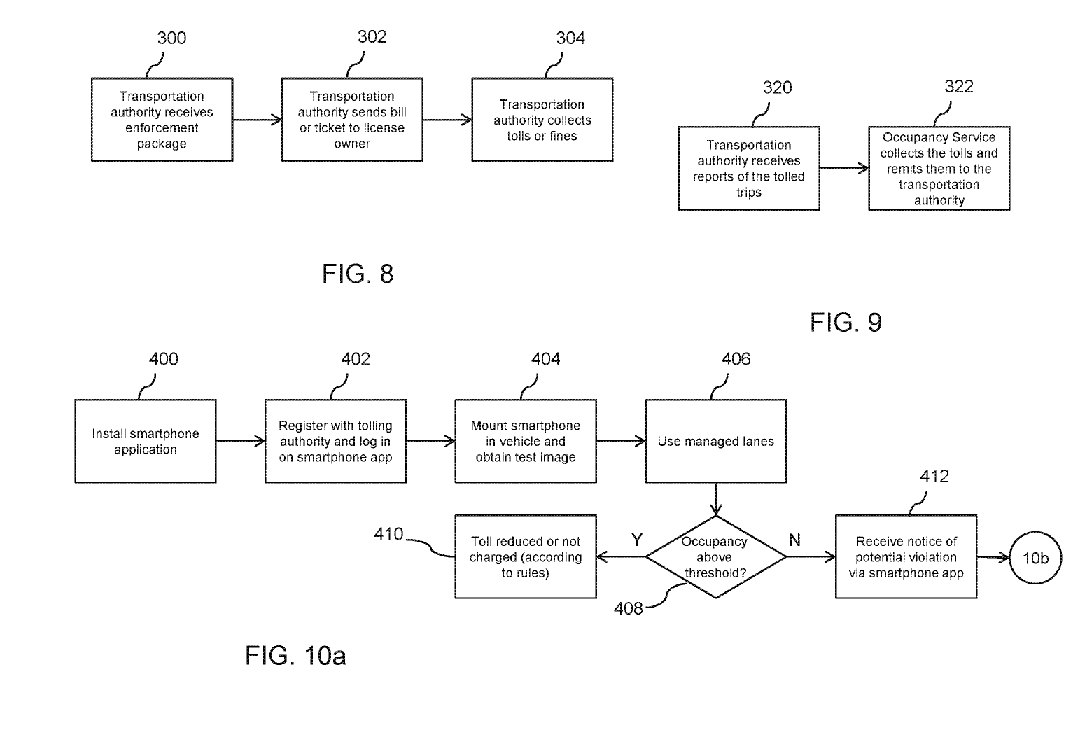

As discussed above, the backend enforcement system 20 can be configured in various ways providing responsibilities to one or more parties. For example, as shown in FIG. 8, the transportation authority 32 can take full responsibility for enforcement by receiving the enforcement package at 300 and sending the bill or ticket to the license owner at step 302 if necessary and then collect the tolls, fines, etc. at step 304. Alternatively, as shown in FIG. 9, the transportation authority 32 can receive reports of the tolled trips or potential fines at step 320 rather than the enforcement package, and have the occupancy service 30 collect the tolls/fines and remit them to the transportation authority 32 at step 322.

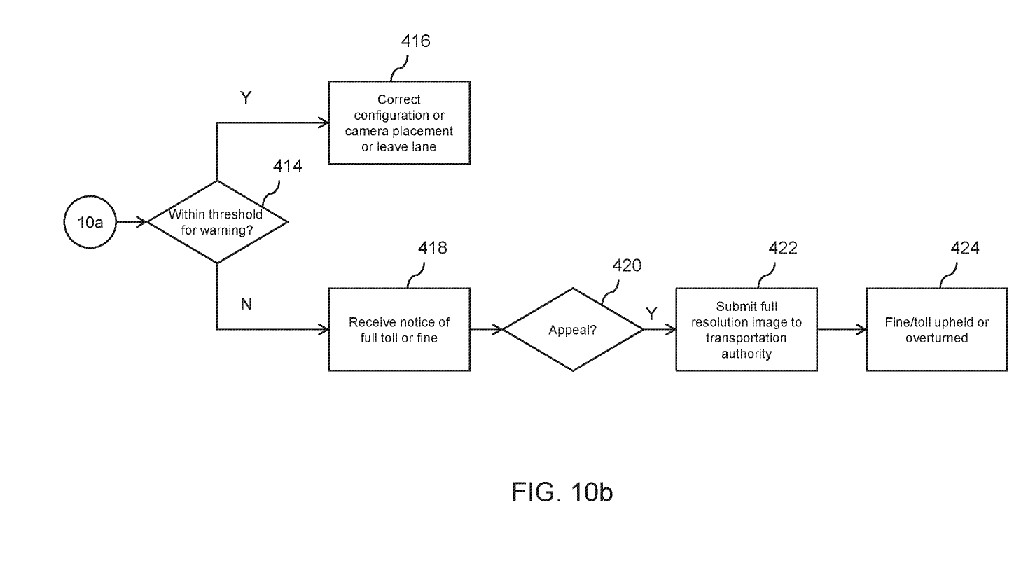

FIGS. 10a and 10b illustrate such interactions from a user's perspective wherein at step 400 the user installs the occupancy app 50 and registers with the tolling authority at step 402. Their smartphone is then mounted in the vehicle at step 404 and the managed lanes 12 used thereafter at step 406. The system determines at step 408 if the occupancy is above the particular threshold for that managed lane 12 and if so, a toll may be reduced or not charged according to the rules for that manage lane 12 at step 410. If the occupancy is not above the threshold, the user can receive a notice of a potential violation at step 412. This can be done through the occupancy app 50 or some other communication method such as text message, email, voicemail, etc. Referring now to FIG. 10b, if the user is within a threshold for a warning, they may correct the configuration or leave the managed lane 12 at step 416. If not, the user receives a notice of the full toll being applied or a fine being issued at step 418. Because the occupancy app 50 acquires and saves the images, the user can be provided with a mechanism to initiate an appeal at step 420 in which case the user can submit a full resolution image to the transportation or enforcement agency at step 422 to dispute the full toll or fine. This allows the user to have incorrect detection operations corrected. The transportation or enforcement agency can uphold or overturn the toll or fine at step 424 based on the appeal process. It can be appreciated that the occupancy app 50 can include user interfaces for participating in such an appeal process which enables convenient dispute resolution for both parties, using the existing technology framework used to perform detection and billing.

The occupancy service 30 can be responsible at least in part for processing in-vehicle images to determine vehicle occupancy, e.g., using deep learning computer vision algorithms and technology, including convolutional neural networks (CNNs), to detect and find the objects of interest (i.e. occupants) in the images. These objects of interest can be detected by finding boundaries of the occupants, the centroid of each occupant, by validating that something is present in a seat, etc. An example of a suitable platform for hosting or otherwise providing the occupancy service 30 can be found in co-pending U.S. Patent Publication No. 2017/0103267 (267) entitled “Machine Learning Platform for Performing Large Scale Data Analytics”, the contents of which are incorporated herein by reference.

The occupancy service 30 can also employ various computer vision algorithms, including commercially available neural networks such as Alexnet, Googlenet, and Eigen. The occupancy service 30 can advantageously employ algorithms based on deep active contours (DACs) such as that described in co-pending U.S. patent application Ser. No. 15/609,212 (212) entitled “System and Method for Performing Saliency Detection Using Deep Active Contours”, the contents of which are incorporated herein by reference. Similarly, compression and/or obfuscation of the data can be performed by the occupancy service 30 using the system and methods described in co-pending U.S. patent application Ser. No. 14/957,079 entitled “System and Method for Compressing Video Data”, the contents of which are incorporated herein by reference. Such a system can also provide a suitable “hash” function that the local device can send to the service 30 as proof of the occupancy of the vehicle 10, without requiring the original image to be seen.

Deep learning for traffic event detection has been found to provide desirable accuracy because, given the ground truth, the system can determine what the model should be. Previous algorithms for traffic event detection were found to rely on developing ever more sophisticated heuristics to emulate a learning system. Traffic event detectors based on these algorithms were considered unable to achieve the accuracy required for real-time detection. The deep learning approach instead makes machine learning all about data, both in terms of the quality and quantity of data. The training set that the occupancy service 30 has available to train its algorithm when deployed as described in the '267 patent application publication is found to be advantageous, particularly when also utilizing the DAC approach described in the '212 application. Such a system can take advantage of the ability to refine its training set from potentially millions of hours of video data processed for customers in other traffic-related applications. It can be appreciated that this current DAC approach is particularly suited for identifying vehicle occupants because it has been trained at least in part to identify pedestrians in traffic video.

The applicants have observed results from work conducted on vehicle localization and classification that show the potential for between 93% and 94% classification accuracy between pedestrians and other vehicles. In such work, various simple and highly complex algorithms were utilized, with the highest scoring algorithm in that particular example to be the Joint Fine-Tuning with DropCNN algorithm, described in: H. Jung, M K Choi, J. Jung, J H Lee, S. Kwon, W Y Jung “ResNet-based Vehicle Classification and Localization in Traffic Surveillance Systems”, Traffic Surveillance Workshop and Challenge, CVPR 2017.

The system described herein provides or can be further adapted to provide various additional advantages. For instance, enforceability and security can be enhanced by having the occupancy app 50 digitally sign photos so that they cannot be altered. Also, taking a photograph inside the vehicle 10 is expected to provide the clearest view of vehicle occupants 46 without being affected by weather. It is expected to be relatively easy to position the smartphone 24 so that one or two passengers appear in a photo taken with a front-facing camera.

The proposed system also readily integrates with other tolling technologies. For example, in real time, the occupancy service 30 or the transportation authority 32 can confirm that a vehicle 10 is registered. Also, when the user's data connection is good enough, the number of occupants 46 can be made available in near real-time. When the image or number of occupants needs to be queued until it can be uploaded, the number of occupants would be available shortly after.

In terms of safety and convenience, implements such as windshield smartphone mounts 64 are normally inexpensive, widely available, and easy to use. Moreover, in areas where restrictions on cellphone use that require hands-free operation exist, smartphone mounts 64 are widely used thus easing adoption of the in-vehicle setup. It can also be appreciated that the user can calibrate the occupancy app 50 using a configuration tool before they begin driving and the occupancy app 50 can be configured to not allow or require user input on the road. The occupancy app 50 can also be configured to avoid using the camera flash to ensure that it does not distract the driver.

With respect to data security and privacy, the exchanged information can be encrypted in the occupancy service's environment, and transmitted over VPN. User privacy can also be protected by limiting the amount of personal information that is stored, and destroying personal information as soon as it is no longer needed. For example, the license plate number can be used to look up the account and, if the system detects a violation, the license plate number and photograph are transmitted to the transportation authority. After the transportation authority confirms receipt, the photograph could then be destroyed and the license plate number only stored in pseudonymized form. The pseudonymized license plate allows the occupancy service 30 to provide the transportation authority 32 with access to origin-destination and travel time reports.

Also, the acquired image is used to detect vehicle occupancy. If the system detects a violation, the image can be transmitted to the transportation authority 32 in a form that protects the user's privacy. For example, a low resolution black-and-white photo can be sent. The original photo could then remain on the user's smartphone 24 for the aforementioned appeal process, e.g. for a manual review initiated by the user.

While the examples described herein mention occupancy detection with respect to managed traffic lanes or traffic areas, it can be appreciated that the principles described herein can equally apply to other applications in which vehicle occupancy is desired. For example, parking lots can provide carpooling incentives by way of reduce parking fares or premium parking spots and adapt the system shown in FIG. 1 to perform vehicle occupancy detection at the entrance to a parking garage or lot. In another example, vehicle occupancy detection can be used at a border crossing to determine the number of passengers entering or leaving a jurisdiction or returning on a subsequent trip. Similarly, some enforced areas such as parks, drive-in movie theaters, theme parks and other establishments that admit based on a number of persons rather than on a per-vehicle basis could also employ the principles described herein.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the occupancy app 50, backend system 20 or occupancy service 30, wireless connectivity system 18, any component of or related thereto, or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of enabling vehicle occupancy to be determined, the method comprising:
acquiring an image in the vehicle after determining that the vehicle is in or approaching an enforced area; and
enabling the vehicle occupancy to be determined by wirelessly sending the image or a value indicative of the vehicle occupancy to an occupancy determining system.

2. The method of claim 1, further comprising associating a time and location with the acquired image.

3. The method of claim 2, further comprising receiving a query from the system to obtain an image associated with a time and/or location, the time and/or location determined based on an external vehicle detection performed for the enforced area.

4. The method of claim 1, further comprising obtaining a location for the vehicle and determining that the location is associated with an enforced area prior to acquiring the image.

5. The method of claim 1, further comprising receiving a threshold warning to adjust an imaging device or to leave the enforced area.

6. The method of claim 1, wherein the image is acquired using a smartphone camera and the image or value indicative of the vehicle occupancy is sent to the system by an occupancy app on the smartphone.

7. The method of claim 1, further comprising processing the image using a computer vision algorithm to determine the value indicative of the vehicle occupancy.

8. The method of claim 7, wherein the computer vision algorithm utilizes deep active contours based on deep learning using a convolution neural network to detect and find boundaries of objects of interest.

9. A method of determining vehicle occupancy, the method comprising:
receiving a vehicle identifier obtained by a vehicle detection camera at an enforced area;
using the vehicle identifier to determine an associated user;
sending a query to an occupancy app residing on a device for the associated user, the device being located in a vehicle corresponding to the vehicle identifier and configured to obtain in-vehicle images;
receiving, in response to the query, an image or a value indicative of the vehicle occupancy to determine the vehicle's occupancy; and
sending an occupancy event to an enforcement agency associated with the enforced area.

10. The method of claim 9, wherein a time and/or location associated with when and where the vehicle identifier was acquired is sent with the query.

11. The method of claim 9, further comprising processing the image using a computer vision algorithm to determine the value indicative of the vehicle occupancy.

12. The method of claim 11, wherein the computer vision algorithm utilizes deep active contours based on deep learning using a convolution neural network to detect and find boundaries of objects of interest.

13. The method of claim 9, wherein sending the occupancy event causes the enforcement agency to associate the value indicative of the vehicle occupancy with a vehicle registry to eliminate an enforcement action when the vehicle occupancy meets a predetermined threshold.

14. A method of enabling vehicle occupancy to be determined, the method comprising:
acquiring at least one audio recording obtained from within the vehicle after determining that the vehicle is in or approaching an enforced area; and
enabling the vehicle occupancy to be determined by wirelessly sending the at least one audio recording or a value indicative of the vehicle occupancy to an occupancy determining system.

15. A non-transitory computer readable medium comprising computer executable instructions for enabling vehicle occupancy to be determined, comprising instructions for:
acquiring an image in the vehicle after determining that the vehicle is in or approaching an enforced area; and
enabling the vehicle occupancy to be determined by wirelessly sending the image or a value indicative of the vehicle occupancy to an occupancy determining system.

16. A non-transitory computer readable medium comprising computer executable instructions for determining vehicle occupancy, comprising instructions for:
receiving a vehicle identifier obtained by a vehicle detection camera at an enforced area;
using the vehicle identifier to determine an associated user;
sending a query to an occupancy app residing on a device for the associated user, the device being located in a vehicle corresponding to the vehicle identifier and configured to obtain in-vehicle images;
receiving, in response to the query, an image or a value indicative of the vehicle occupancy to determine the vehicle's occupancy; and
sending an occupancy event to an enforcement agency associated with the enforced area.

17. A non-transitory computer readable medium comprising computer executable instructions for enabling vehicle occupancy to be determined, comprising instructions for:
acquiring at least one audio recording obtained from within the vehicle after determining that the vehicle is in or approaching an enforced area; and
enabling the vehicle occupancy to be determined by wirelessly sending the at least one audio recording or a value indicative of the vehicle occupancy to an occupancy determining system.

18. A system for determining vehicle occupancy, the system comprising a processor, data communication interface, and memory, the memory comprising computer executable instructions for: receiving a vehicle identifier obtained by a vehicle detection camera at an enforced area; using the vehicle identifier to determine an associated user; sending a query to an occupancy app residing on a device for the associated user, the device being located in a vehicle corresponding to the vehicle identifier and configured to obtain in-vehicle images; receiving, in response to the query, an image or a value indicative of the vehicle occupancy to determine the vehicle's occupancy; and sending an occupancy event to an enforcement agency associated with the enforced area.
